(19) United States
(12) Patent Application Publication
(10) Pub. No.: US 2017/0351288 A1
(43) Pub. Date: Dec. 7, 2017

(54) NON-INVASIVE ONLINE REAL-TIME ELECTRIC LOAD IDENTIFICATION METHOD AND IDENTIFICATION SYSTEM

(71) Applicant: Shenzhen Zhidian Energy Technology LTD, Shenzhen City (CN)

(72) Inventors: Zuyi LI, Shenzhen City (CN); Zhen BAO, Shenzhen City (CN); Mengmeng ZHUANG, Shenzhen City (CN)

(21) Appl. No.: 15/615,325

(22) Filed: Jun. 6, 2017

(30) Foreign Application Priority Data
Jun. 7, 2016 (CN) 201610397458.4

(51) Int. Cl. G05F 1/66; G05B 15/02

(52) U.S. Cl. CPC G05F 1/66; G05B 15/02

(57) ABSTRACT

The present invention belongs to the technical field of the Internet of things and big data, and relates to a non-invasive online real-time electric load identification method and an identification system. The present invention solves the technical problems, for example, the existing designs are not so rational. The method comprises the following steps: A. acquisition of real-time electric power signals; B. non-invasive load identification and analysis; and C. result feedback. The system comprises at least one embedded device terminal which is connected to a distribution box on a resident side. The embedded device terminal is connected to the cloud; the cloud is collected to a background server; and the background server is connected to a data memory and is able to transmit a result of analysis to a terminal device corresponding to the distribution box on the resident side. The present invention has the following advantages: for a user on a resident side, the usage cost is low and training can be performed without a large amount of labeled samples; the method and system are very sensitive to a low-load electric appliance, and can solve the electric energy oscillation problem, and ensure the accuracy of load identification, so that an overall energy source solution may be provided for families. Moreover, the algorithm efficiency may achieve the online and real-time effects.

### TECHNICAL FIELD OF THE INVENTION

The present invention belongs to the technical field of the Internet of things and big data, and relates to the power consumption monitoring and state detection, in particular to a non-invasive online real-time electric load identification method and an identification system.

### BACKGROUND OF THE INVENTION

Load identification has been proposed by Hart from the Massachusetts Institute of Technology in 1880s. To alleviate the global energy shortage and environmental pollution, load identification technologies have attracted more and more attention recently. Load identification is aimed at detecting the power consumption and real-time state of electric appliances in families. Load identification may help power grid enterprises to provide load-side response services and household appliance failure detection services for the resident side. Wherein, load identification is classified into invasive load monitoring technologies and non-invasive load identification technologies. For the invasive load monitoring, each household appliance is additionally provided with a sensor for measuring the power consumption and state of the electric appliance in real time. For the non-invasive load identification technologies, only the total real-time electric power of the family is to be measured, and the state and power consumption of all household appliances are identified by machine learning and by an artificial intelligence algorithm. In comparison with the invasive load monitoring, the non-invasive load identification has the advantages of low cost, convenient mounting and the like. At present, majority of solutions uses clustering algorithms, hidden Markov models, neural networks and support vector machines to realize the identification process.

However, the existing load identification technologies have the following limitations: a large amount of labeled samples are required for training; only high-load power consumers can be identified, for example, refrigerators, air conditioners and the like; due to the shortage of a large amount of training samples, the identification accuracy is relatively low; the hardware cost is high and it is not feasible for deployment in the residence; and, the load identification technologies are low in algorithm efficiency and generally unable to achieve the real-time and online effects. Therefore, by long-term exploration, various solutions have been proposed. For example, a Chinese Patent Document No. 201410389560.0 has disclosed a system architecture for implementing a non-invasive electric load monitoring and decomposition technology, including: a non-invasive electric load monitoring and decomposition service management module deployed on the technique service provider side, a non-invasive electric load monitoring and decomposition functional module, a distributed network expansion functional module and a bidirectional communication network transmission module all deployed on the user side. In the present invention, from the perspective of the system application and market popularization of the NILMD technology system, the first attempt is to establish, on the basis of analysis of practical demands for the NILMD technology, a system architecture for implementing non-invasive electric load monitoring and decomposition technology (NILMDSI) which is capable of supporting the extensive practicability of the NILMD technology. The present invention may fill up the research gap in this aspect, and may instruct the technique provider to formulate feasible and effective systematic implementation schemes for the practice and popularization of the NILMD technology, so that related problems on the practice of the NILMD technology may be better solved.

Those schemes cannot fundamentally solve the technical problems in the prior art although they have optimized the non-invasive electric load monitoring and decomposition hardware architecture to a certain extent.

### SUMMARY OF THE INVENTION

In view of the problems described above, an objective of the present invention is to provide a non-invasive online real-time electric load identification method which is low in usage cost and very sensitive to low-load electric appliances, can be trained without a large amount of labeled samples, can solve the oscillation problem of electric energy and ensures the accuracy of load identification.

Another objective of the present invention is to provide a non-invasive online real-time electric load identification system which is low in usage cost and very sensitive to low-load electric appliances, can be trained without a large amount of labeled samples, can solve the oscillation problem of electric energy and ensures the accuracy of load identification.

To achieve the objectives, the present invention employs the following technical solutions. A non-invasive online real-time power load identification method is provided, including the following steps:

A. acquisition of real-time electric power signals: collecting real-time electric power data from a distribution box on a resident side in real time, and converting the collected real-time electric power data to obtain real-time electric power signals;

B. non-invasive load identification and analysis: performing wavelet transform de-nosing on the real-time electric power signals; detecting an event by kernel density estimation; judging whether there are periodic signals and calculating a period, removing periodic signals and extracting trend signals; clustering the electric power signals; and extracting electric power signal features, so as to obtain power consumption data and real-time state information of each household appliance corresponding to the distribution box on the resident side; and

C. result feedback: feeding the analyzed power consumption data and real-time state information of each household appliance corresponding to the distribution box on the resident side back to a resident-side user corresponding to the distribution box on the resident side.

In the non-invasive online real-time power load identification method, in the step B,

(1) wavelet transform de-nosing: a relationship between the real-time electric power signals yᵢ and real electric power signals f(xᵢ) is set as follows: yᵢ=f(x)+eᵢ,iε{1, . . . , n}, where eᵢ is an error, and n is a natural number;

according to the principle of wavelet transform:

$${f}_{J} ( x ) = α φ ( x ) + {\sum }_{j = 0}^{J} {\sum }_{k = 0}^{{2}^{j} - 1} {β}_{j k} {ϕ}_{j k} ( x ) ;$$

$${ϕ}_{j , k} ( x ) = {2}^{j / 2} ϕ ( {2}^{j} x - k ) ;$$

$$φ ( x ) = {I}_{( 0 , 1 )} ( x ) ;$$

where a=∫₀¹f(x)φ(x)dx is a scale coefficient, βⱼₖ=∫₀¹f(x)φⱼₖ(x)dx is a detail coefficient φⱼₖ(x) is a primary function;

the error eᵢ is set to conform to a Gaussian distribution with a mean of 0, and a threshold is set so that de-noising is performed on the real-time electric power signals;

the threshold is selected: λ=\hat{σ}\sqrt{2log(N)};

where N is a signal length, and \hat{σ} is a robust estimator; high-frequency noise signals are removed and low-frequency signals are reserved by the wavelet transform de-noising through time-frequency analysis;

(2) detecting an event by kernel density estimation: kernel density estimation is performed on the de-noised real-time electric power signals to estimate signal distribution,

a density function is as follows:

$${ρ}_{K} ( y ) = {\sum }_{i = 1}^{N} K ( ( y - {x}_{i} ) / h ) ;$$

where K is the density function, y is an original signal, xᵢ is an expected value of the density function, and h is the bandwidth of the density function; if the signal distribution has two or more peak points, the result of judgment indicates that an event occurs; or otherwise, no event occurs;

(3) judging whether there are periodic signals and calculating a period, removing periodic signals and extracting trend signals: for the real-time electric power signals on which an event occurs, it is judged whether there are periodic signals,

an autocorrelation coefficient of the signals is calculated:

$$r = \frac{Σ ( {x}_{i} - \overline{x} ) ( {y}_{i} - \overline{y} )}{{{[ {Σ ( {x}_{i} - \overline{x} )}^{2} ]}^{1 / 2} [ {Σ ( {y}_{i} - \overline{y} )}^{2} ]}^{1 / 2}} ;$$

if there is a correlation between the signals, that is, if the autocorrelation coefficient is not less than 0.95, periodic signals are removed by solving by a Hodrick-Prescott filter optimization algorithm, and the specific implementation process is as follows:

$${Tr}_{t}^{HP} = arg {min}_{{\{ {Tr}_{t} \}}_{t = 1}^{T}} {\sum }_{t = 1}^{T} {( {y}_{t} - {Tr}_{t} )}^{2} + λ {\sum }_{t = 2}^{T - 1} {[ ( {Tr}_{t + 1} - {Tr}_{t} ) - ( {Tr}_{t} - {Tr}_{t - 1} ) ]}^{2}$$

where the solving result Trₜ^{HP} is the removed periodic signal, y is the original signal, and λ is a penalty coefficient; energy oscillation signals are removed from the removed periodic signals and trend signals hidden in the energy oscillation are reserved, so as to extract trend signals;

(4) clustering the electric power signals: outliers are solved according to the extracted trend signals and by a density-based clustering algorithm, the outliers being essentially transient-state signals of the event; and, the specific process is as follows: marking all points as core points, boundary points or noise points; deleting the noise points, endowing an edge between all core points having a distance within a threshold; forming a cluster by each group of connected core points; and assigning each boundary point to a cluster of core points associated with this boundary point, so that transient-state signals are separated from stable-state signals by the density-based clustering algorithm and the transient-state signals are positioned; and (5) extracting electric power signal features: feature compression is performed by deep learning, and feature identification is performed by an unsupervised density-based clustering algorithm.

In the non-invasive online real-time power load identification method, in the step A, the real-time electric power data includes real-time voltage and real-time current; and, the real-time electric power data is converted into real-time active power signals and real-time reactive power signals.

In the non-invasive online real-time power load identification method, the real-time electric power signals are transmitted to the cloud by wireless and/or wired communication and then transmitted from the cloud to a background server by wireless and/or wired communication, and the non-invasive load identification and analysis is performed in the background server.

In the non-invasive online real-time power load identification method, the real-time electric power signals are transmitted to the cloud by an Ethernet and/or WiFi communication protocol, and then transmitted from the could to the background server via the Internet.

A non-invasive online real-time power load identification system using the non-invasive online real-time power load identification method is provided, wherein the system includes at least one embedded device terminal which is connected to a distribution box on a resident side and configured to acquire real-time electric power signals; the embedded device terminal is connected to the cloud by wireless and/or wired communication, and the cloud is collected to a background server capable of performing non-invasive load identification and analysis on the real-time electric power signals by wireless and/or wired communication; and, the background server is connected to a data memory and is able to transmit a result of analysis to a terminal device corresponding to the distribution box on the resident side by wireless and/or wired communication.

In the non-invasive online real-time power load identification system, the real-time electric power signals are transmitted to the cloud by an Ethernet and/or WiFi communication protocol, and then transmitted from the could to the background server via the Internet.

In the non-invasive online real-time power load identification system, there is a plurality of embedded device terminals which are connected to the cloud in a distributed connection manner.

In the non-invasive online real-time power load identification system, the terminal device is a mobile terminal device and/or a PC.

In the non-invasive online real-time power load identification system, the household appliance includes a high-load power consumer and/or a low-load power consumer.

Compared with the prior art, the non-invasive online real-time power load identification method and system have the following advantages: for a user on a resident side, the usage cost is low and training can be performed without a large amount of labeled samples; the method and system are very sensitive to a low-load electric appliance, and can solve the electric energy oscillation problem, and ensure the accuracy of load identification, so that an overall energy source solution may be provided for families. Moreover, the algorithm efficiency may achieve the online and real-time effects.

### BRIEF DESCRIPTION OF THE DRAWINGS

FIG. 1 is a structural block diagram according to the present invention;

FIG. 2 is a flowchart of an event detection algorithm according to the present invention;

FIG. 3 is a schematic diagram of a grid structure for deep learning according to the present invention;

FIG. 4 is a diagram showing original electric power signals according to the present invention;

FIG. 5 is a diagram showing an event judgment effect by a kernel method according to the present invention;

FIG. 6 is a partially structural block diagram of an embedded device terminal according to the present invention;

FIG. 7 is a partial circuit diagram of the embedded device terminal according to the present invention;

in which:

1: distribution box on a resident side;

11: AC voltage source;

12: AC current source;

2: the cloud;

3: background server;

4: embedded device terminal;

41: first operation circuit;

42: second operation circuit;

43: power supply source;

44: transformer;

45: rectifier circuit;

46: filter circuit;

47: voltage stabilizer circuit;

48: smooth output voltage circuit;

6: data memory; and

7: terminal device.

### DETAILED DESCRIPTION OF THE INVENTION

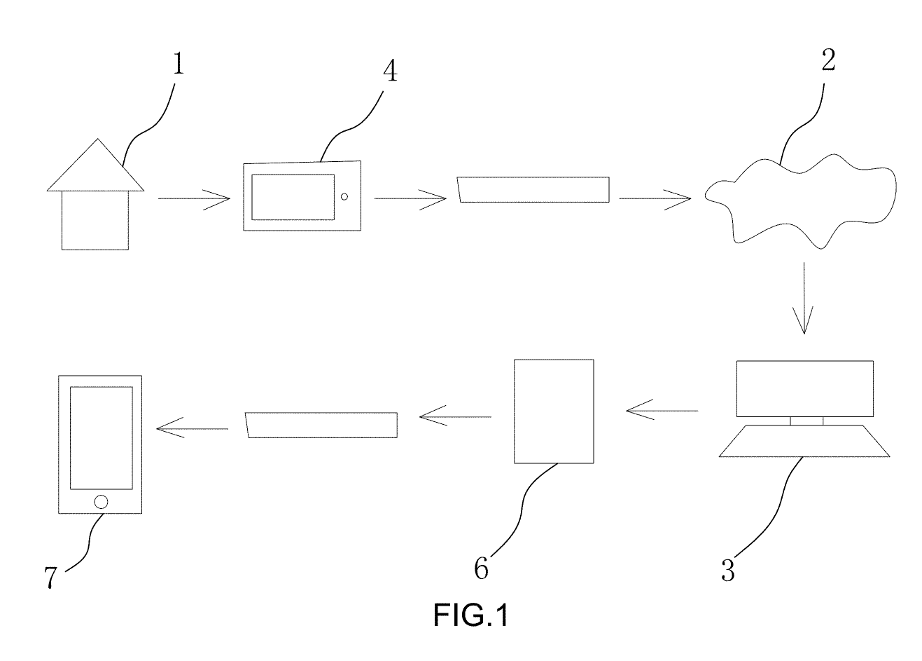

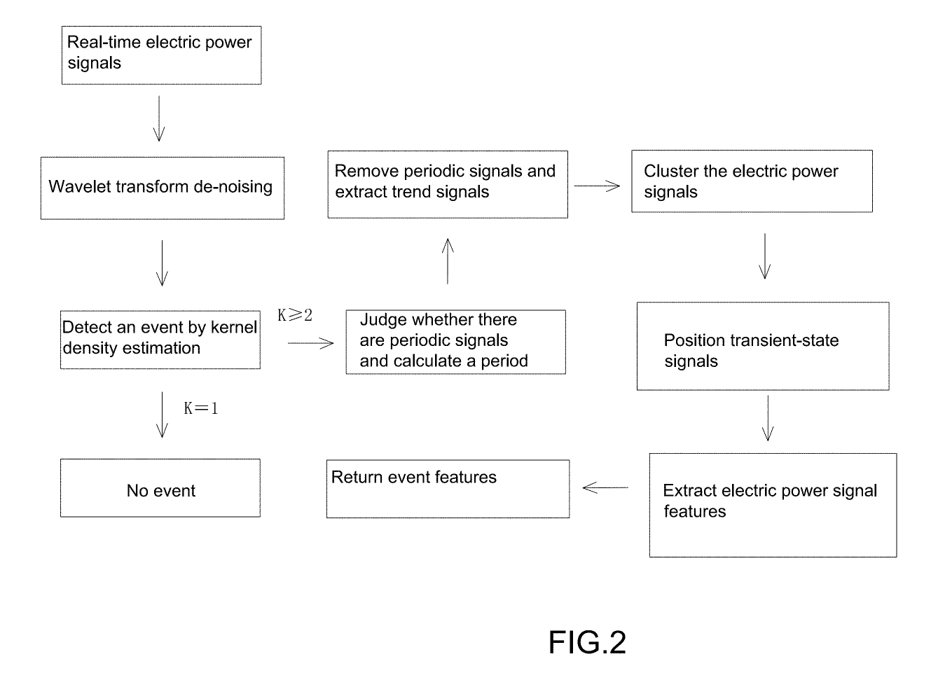

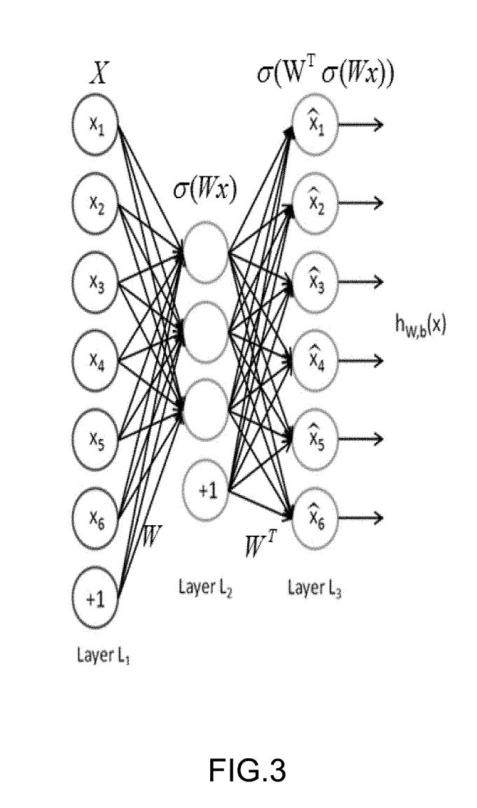

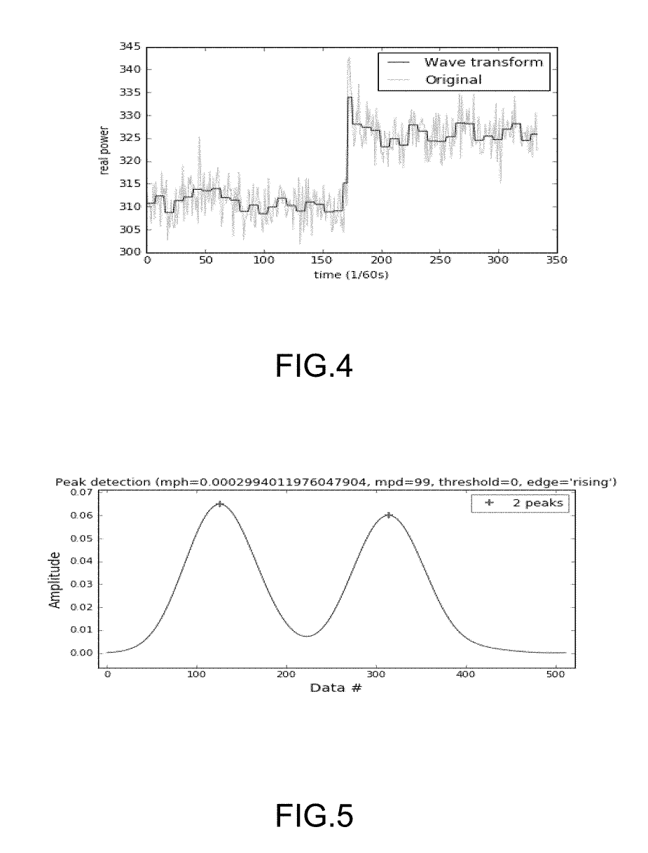

As shown in FIGS. 1-7, the non-invasive online real-time electric load identification method includes the following steps:

A. acquisition of real-time electric power signals: collecting real-time electric power data from a distribution box 1 on a resident side in real time, and converting the collected real-time electric power data to obtain real-time electric power signals, wherein the real-time electric power data includes operational data such as real-time voltage and real-time current, and the real-time electric power data are converted into real-time active power signals and real-time reactive power signals;

B. non-invasive load identification and analysis: performing wavelet transform de-nosing on the real-time electric power signals; detecting an event by kernel density estimation; judging whether there are periodic signals and calculating a period, removing the periodic signals and extracting trend signals; clustering the electric power signals; and extracting electric power signal features, so as to obtain power consumption data and real-time state information of each household appliance corresponding to the distribution box 1 on the resident side; and

C. result feedback: feeding the analyzed power consumption data and real-time state information of each household appliance corresponding to the distribution box 1 on the resident side back to a resident-side user corresponding to the distribution box 1 on the resident side.

Here, the real-time electric power signals are transmitted to the cloud 2 by wireless and/or wired communication and then transmitted from the cloud 2 to a background server 3 by wireless and/or wired communication, and the non-invasive load identification and analysis is performed in the background server 3. The real-time electric power signals are transmitted to the cloud 2 by an Ethernet and/or WiFi communication protocol, and then transmitted from the could 2 to the background server 3 via the Internet.

More specifically, in the step B,

(1) wavelet transform de-nosing: a relationship between the real-time electric power signals yᵢ and real electric power signals f(xᵢ) is set as follows: yᵢ=f(x)+eᵢ,iε{1, . . . , n}, where eᵢ is an error, and n is a natural number;

according to the principle of wavelet transform:

$${f}_{J} ( x ) = α φ ( x ) + {\sum }_{j = 0}^{J} {\sum }_{k = 0}^{{2}^{j} - 1} {β}_{jk} {ϕ}_{jk} ( x ) ;$$

$${ϕ}_{j , k} ( x ) = {2}^{j / 2} ϕ ( {2}^{j} x - k ) ;$$

$$φ ( x ) = {I}_{( 0 , 1 )} ( x ) ;$$

where a=∫₀¹f(x)φ(x)dx is a scale coefficient, βⱼₖ=∫₀¹f(x)φⱼₖ(x)dx is a detail coefficient and φⱼₖ(x) is a primary function;

the error eᵢ is set to conform to a Gaussian distribution with a mean of 0, and a threshold is set so that de-noising is performed on the real-time electric power signals;

the threshold is selected: λ=\hat{σ}\sqrt{2log(N)};

where N is a signal length, and \hat{σ} is a robust estimator; high-frequency noise signals are removed and low-frequency signals are reserved by the wavelet transform de-noising through time-frequency analysis;

(2) detecting an event by kernel density estimation: kernel density estimation is performed on the de-noised real-time electric power signals to estimate signal distribution,

a density function is as follows:

$${ρ}_{K} ( y ) = {\sum }_{i = 1}^{N} K ( ( y - {x}_{i} ) / h ) ;$$

where K is the density function, y is an original signal, xᵢ is an expected value of the density function, and h is the bandwidth of the density function; if the signal distribution has two or more peak points, the result of judgment indicates that an event occurs; or otherwise, no event occurs;

(3) judging whether there are periodic signals and calculating a period, removing periodic signals and extracting trend signals: for the real-time electric power signals on which an event occurs, it is judged whether there are periodic signals,

an autocorrelation coefficient of the signals is calculated:

$$r = \frac{Σ ( {x}_{i} - \overline{x} ) ( {y}_{i} - \overline{y} )}{{{[ {Σ ( {x}_{i} - \overline{x} )}^{2} ]}^{1 / 2} [ {Σ ( {y}_{i} - \overline{y} )}^{2} ]}^{1 / 2}} ;$$

if there is a correlation between the signals, that is, if the autocorrelation coefficient is not less than 0.95, periodic signals are removed by solving by a Hodrick-Prescott filter optimization algorithm, and a specific implementation process is as follows:

$${Tr}_{t}^{HP} = arg {min}_{{\{ {Tr}_{t} \}}_{t = 1}^{T}} {\sum }_{t = 1}^{T} {( {y}_{t} - {Tr}_{t} )}^{2} + λ {\sum }_{t = 2}^{T - 1} {[ ( {Tr}_{t + 1} - {Tr}_{t} ) - ( {Tr}_{t} - {Tr}_{t - 1} ) ]}^{2}$$

where the solving result Trₜ^{HP} is the removed periodic signal, y is the original signal, and λ is a penalty coefficient; energy oscillation signals are removed from the removed periodic signals and trend signals hidden in the energy oscillation are reserved, so as to extract trend signals;

(4) clustering the electric power signals: outliers are solved according to the extracted trend signals and by a density-based clustering algorithm, the outliers being essentially transient-state signals of the event; and, the specific process is as follows: marking all points as core points, boundary points or noise points; deleting the noise points, endowing an edge between all core points having a distance within a threshold; forming a cluster by each group of connected core points; and assigning each boundary point to a cluster of core points associated with this boundary point, so that transient-state signals are separated from stable-state signals by the density-based clustering algorithm and the transient-state signals are positioned; and

(5) extracting electric power signal features: feature compression is performed by deep learning, and feature identification is performed by an unsupervised density-based clustering algorithm.

A non-invasive online real-time power load identification system using the non-invasive online real-time power load identification method is provided, wherein the system includes at least one embedded device terminal 4 which is connected to a distribution box 1 on a resident side and configured to acquire real-time electric power signals; the embedded device terminal 4 is connected the cloud 2 by wireless and/or wired communication, and the cloud 2 is connected to a background server 3 capable of performing non-invasive load identification and analysis on the real-time electric power signals by wireless and/or wired communication; and, the background server 3 is connected to a data memory 6 and is able to transmit a result of analysis to a terminal device 7 corresponding to the distribution box 1 on the resident side by wireless and/or wired communication. The real-time electric power signals are transmitted to the cloud 2 by an Ethernet and/or WiFi communication protocol, and then transmitted from the could 2 to the background server 3 via the Internet. There is a plurality of embedded device terminals 4 which are connected to the cloud 2 in a distributed connection manner. The terminal device 4 is a mobile terminal device and/or a PC, for example, a smart phone, a PAD, a notebook computer and the like. The household appliance includes a high-load power consumer and/or a low-load power consumer, i.e., a refrigerator, an air conditioner, a phone charger, a lamp, a computer and the like.

In the present application, training can be performed without a large amount of labeled samples; high-load and low-load power consumers can be identified; few training samples are required, and the identification accuracy is relatively high; and the hardware cost is low, and it is easy for deployment in the residence. In the present application, the non-invasive load identification is performed based on signal processing, machine learning, artificial intelligence and other technologies, so as to provide an overall energy source solution for the families. Wherein, the involved core technologies mainly include: performing wavelet analysis de-noising, detecting an event by kernel density estimation, removing periodic signals and extracting trend information by an autocorrelation coefficient and by an optimization method, separating transient-state signals from stable-state signals by a density-based clustering method, extracting electric power signal features by a sparse self-coding technology in the deep learning, and the like.

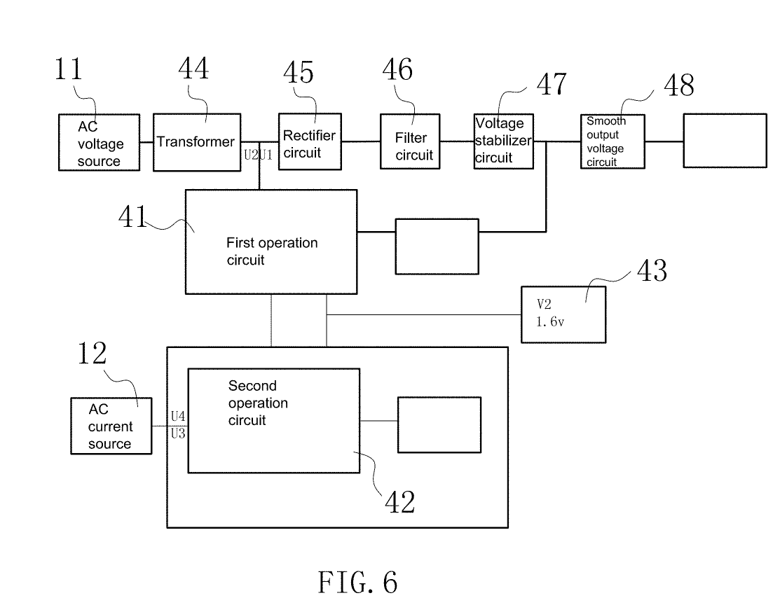

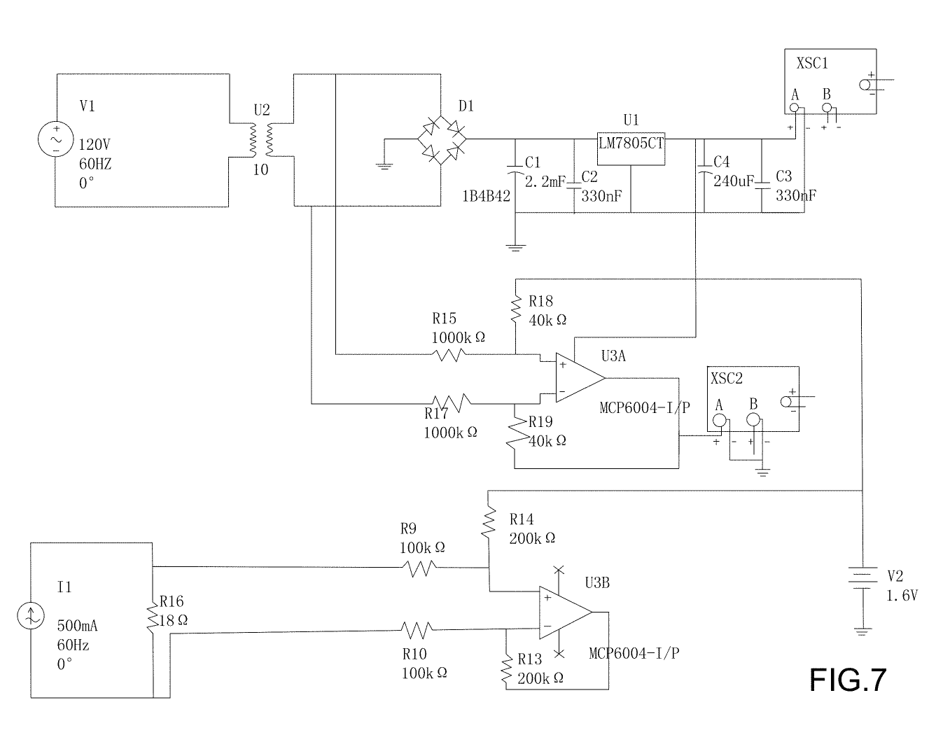

As shown in FIGS. 6 and 7, the embedded device terminal 4 includes a first operation circuit 41 and a second operation circuit 42 which are connected to each other. Both the first operation circuit 41 and the second operation circuit 42 are connected to a power supply source 43. The first operation circuit 41 and the second operation circuit 42 are connected to the distribution box 1 on the resident side, respectively (that is, the first operation circuit 41 and the second operation circuit 42 are connected to an AC voltage source 11 and an AC current source 12, respectively). The AC voltage source 11 is successively connected to a transformer 44, a rectifier circuit 45, a filter circuit 46, a voltage stabilizer circuit 47 and a smooth output voltage circuit 48.

The specific embodiments described herein merely illustrate the spirit of the present invention. Those skilled in the art may make various modifications or supplements to the specific embodiments described herein or replace the specific embodiments described herein in a similar way, without departing from the spirit of the present invention or the scope defined by the appended claims.

Although terms such as the distribution box 1 on the resident side, the AC voltage source 11, the AC current source 12, the cloud 2, the background server 3, the embedded device terminal 4, the first operation circuit 41, the second operation circuit 42, the power supply source 43, the transformer 44, the rectifier circuit 45, the filter circuit 46, the voltage stabilizer circuit 47, the smooth output voltage circuit 48, the data memory 6 and the terminal device 7 are frequently used herein, the possibility of using other terms is not excluded. These terms are merely used for more conveniently describing and explaining the essence of the present invention, and the interpretation of these terms into any additional limitations shall depart from the spirit of the present invention.

1. A non-invasive online real-time power load identification method, comprising the following steps:
A. acquisition of real-time electric power signals: collecting real-time electric power data from a distribution box (1) on a resident side in real time, and converting the collected real-time electric power data to obtain real-time electric power signals;
B. non-invasive load identification and analysis: performing wavelet transform de-noising on the real-time electric power signals; detecting an event by kernel density estimation; judging whether there are periodic signals and calculating a period, removing periodic signals and extracting trend signals; clustering the electric power signals; and
extracting electric power signal features, so as to obtain power consumption data and real-time state information of each household appliance corresponding to the distribution box (1) on the resident side; and
C. result feedback: feeding the analyzed power consumption data and real-time state information of each household appliance corresponding to the distribution box (1) on the resident side back to a resident-side user corresponding to the distribution box (1) on the resident side.

2. The non-invasive online real-time power load identification method according to claim 1, characterized in that, in the step B,
(1) wavelet transform de-nosing: a relationship between the real-time electric power signals yᵢ and real electric power signals f(xᵢ) is set as follows:
y=f(xᵢ)+eᵢ,iε{1, . . . , n}, where eᵢ is an error, and n is a natural number;
according to the principle of wavelet transform:
$${f}_{J} ( x ) = α φ ( x ) + {\sum }_{j = 0}^{J} {\sum }_{k = 0}^{{2}^{j} - 1} {β}_{jk} {ϕ}_{jk} ( x ) ;$$
$${ϕ}_{j , k} ( x ) = {2}^{j / 2} ϕ ( {2}^{j} x - k ) ;$$
$$φ ( x ) = {I}_{( 0 , 1 )} ( x ) ;$$
where a=∫₀¹f(x)φ(x)dx is a scale coefficient, βⱼₖ =∫₀¹f(x)φⱼₖ(x)dx is a detail coefficient and φⱼₖ(x) is a primary function;
the error eᵢ is set to conform to a Gaussian distribution with a mean of 0, and a threshold is set so that de-noising is performed on the real-time electric power signals;
the threshold is selected: λ=\hat{σ}\sqrt{2log(N)};
where N is a signal length, and \hat{σ} is a robust estimator; high-frequency noise signals are removed and low-frequency signals are reserved by the wavelet transform de-noising through time-frequency analysis;
(2) detecting an event by kernel density estimation: kernel density estimation is performed on the de-noised real-time electric power signals to estimate signal distribution,
a density function is as follows:
$${ρ}_{K} ( y ) = {\sum }_{i = 1}^{N} K ( ( y - {x}_{i} ) / h ) ;$$
where K is the density function, y is an original signal, xᵢ is an expected value of the density function, and h is the bandwidth of the density function; if the signal distribution has two or more peak points, the result of judgment indicates that an event occurs; or otherwise, no event occurs;
(3) judging whether there are periodic signals and calculating a period, removing periodic signals and extracting trend signals: for the real-time electric power signals on which an event occurs, it is judged whether there are periodic signals,
an autocorrelation coefficient of the signals is calculated:
$$r = \frac{Σ ( {x}_{i} - \overline{x} ) ( {y}_{i} - \overline{y} )}{{{[ {Σ ( {x}_{i} - \overline{x} )}^{2} ]}^{1 / 2} [ {Σ ( {y}_{i} - \overline{y} )}^{2} ]}^{1 / 2}} ;$$
if there is a correlation between the signals, that is, if the autocorrelation coefficient is not less than 0.95, periodic signals are removed by solving by a Hodrick-Prescott filter optimization algorithm, and the specific implementation process is as follows:
$${Tr}_{t}^{HP} = arg {min}_{{\{ {Tr}_{t} \}}_{t = 1}^{T}} {\sum }_{t = 1}^{T} {( {y}_{t} - {Tr}_{t} )}^{2} + λ {\sum }_{t = 2}^{T - 1} {[ ( {Tr}_{t + 1} - {Tr}_{t} ) - ( {Tr}_{t} - {Tr}_{t - 1} ) ]}^{2}$$
where the solving result Trₜ^{HP} is the removed periodic signal, y is the original signal, and λ is a penalty coefficient; energy oscillation signals are removed from the removed periodic signals and trend signals hidden in the energy oscillation are reserved, so as to extract trend signals;
(4) clustering the electric power signals: outliers are solved according to the extracted trend signals and by a density-based clustering algorithm, the outliers being essentially transient-state signals of the event; and, the specific process is as follows: marking all points as core points, boundary points or noise points; deleting the noise points, endowing an edge between all core points having a distance within a threshold; forming a cluster by each group of connected core points; and assigning each boundary point to a cluster of core points associated with this boundary point, so that transient-state signals are separated from stable-state signals by the density-based clustering algorithm and the transient-state signals are positioned; and
(5) extracting electric power signal features: feature compression is performed by deep learning, and feature identification is performed by an unsupervised density-based clustering algorithm.

3. The non-invasive online real-time power load identification method according to claim 1, characterized in that, in the step A, the real-time electric power data includes real-time voltage and real-time current; and, the real-time electric power data is converted into real-time active power signals and real-time reactive power signals.

4. The non-invasive online real-time power load identification method according to claim 1, characterized in that the real-time electric power signals are transmitted to the cloud (2) by wireless and/or wired communication and then transmitted from the cloud (2) to a background server (3) by wireless and/or wired communication, and the non-invasive load identification and analysis is performed in the background server (3).

5. The non-invasive online real-time power load identification method according to claim 4, characterized in that the real-time electric power signals are transmitted to the cloud (2) by an Ethernet and/or WiFi communication protocol, and then transmitted from the could (2) to the background server (3) via the Internet.

6. A non-invasive online real-time power load identification system using the non-invasive online real-time power load identification method according to claim 1, characterized in that the system includes at least one embedded device terminal (4) which is connected to a distribution box (1) on a resident side and configured to acquire real-time electric power signals; the embedded device terminal (4) is connected to the cloud (2) by wireless and/or wired communication, and the cloud (2) is collected to a background server (3) capable of performing non-invasive load identification and analysis on the real-time electric power signals by wireless and/or wired communication; and, the background server (3) is connected to a data memory (6) and is able to transmit a result of analysis to a terminal device (7) corresponding to the distribution box (1) on the resident side by wireless and/or wired communication.

7. The non-invasive online real-time power load identification system according to claim 6, characterized in that the real-time electric power signals are transmitted to the cloud (2) by an Ethernet and/or WiFi communication protocol, and then transmitted from the could (2) to the background server (3) via the Internet.

8. The non-invasive online real-time power load identification system according to claim 7, characterized in that there is a plurality of embedded device terminals (4) which are connected to the cloud (2) in a distributed connection manner.

9. The non-invasive online real-time power load identification system according to claim 6, characterized in that the terminal device (4) is a mobile terminal device and/or a PC.

10. The non-invasive online real-time power load identification system according to claim 6, characterized in that the household appliance includes a high-load power consumer and/or a low-load power consumer.
